(19) United States
(12) Patent Application Publication
(10) Pub. No.: US 2003/0154106 A1
(43) Pub. Date: Aug. 14, 2003

(54) System and method for renewing prescriptions

(75) Inventor: James D. Marks, New York, NY (US)

Correspondence Address: DARBY & DARBY P.C., Post Office Box 5257, New York, NY, 10150-5257, US

(73) Assignee: Body Health Resources Corporation, New York, NY

(21) Appl. No.: 10/351,584

(22) Filed: Jan. 24, 2003

Related U.S. Application Data
(60) Provisional application No. 60/351,673, filed on Jan. 25, 2002.

(51) Int. Cl. G06F 15/16; G06F 17/60

(52) U.S. Cl. 705/2; 709/203

(57) ABSTRACT

A system and method for renewing prescriptions is provided. Visitors to a web site, who may or may not register, are given the opportunity to request renewals of drug prescriptions on the web site. Visitors are prompted to enter information relevant to the renewal. The web site in one alternative maintains a database of visitors medical and/or contact information and issues a membership ID or Plan ID. In an alternative the web site may offer an opt-in buyer's club for obtaining discounts or information about prescriptions. The web site, in one alternative, maintains a database of information about doctors who are registered with the web site. The visitor may then select a doctor from a list and use the site to request a prescription renewal from that doctor. The web site uses information entered by the visitor, or information previously provided by the visitor accessed from the web site's database, to format a fax or email to the doctor requesting a renewal of the visitors prescription. The fax or email may contain the name, address, telephone number and prescription plan ID of the patient, the name, address, telephone number and DEA number of the doctor, the drug to be refilled, the quantity and dosage of the refill. The fax or email will contain the fax number and phone number or email address of the pharmacy (or Pharmaceutical Benefits Manager, “PBM”, for example Express Scripts.) Finally, the fax or email will contain a signature line or sufficient facility for electronic signature to be signed by the doctor. Upon completion of the request by the visitor, the system forwards the request directly to the doctor via fax or electronically. The doctor may then sign the request and fax or electronically transmit the request to a pharmacy or PBM.

### FIELD OF THE INVENTION

The present invention relates to the renewal of prescriptions and, in particular, to the renewal of prescriptions using a network.

### BACKGROUND OF THE INVENTION

Extensive administrative time at a typical doctor's office is spent renewing prescriptions for patients by telephone. In addition to the diversion of staff time, there are other associated burdens such as searching for patient contact and medical information and the additional risk of transcription error.

It would be beneficial to maintain a system that would allow patients to request prescription renewals in writing via the Internet and allow doctors to receive and process those requests via fax, email or the Internet. It would further be beneficial to gather an on-line database containing the contact information of patients, doctors and pharmacies to streamline the transmission of and avoid re-entry of information relevant to renewing prescriptions. It is also beneficial for pharmacies to have their contact and pricing information available on-line as a selection that a user can make when requesting a prescription renewal.

### SUMMARY OF THE INVENTION

A system and method for renewing prescriptions is provided. Visitors to a web site, who may or may not register, are given the opportunity to request renewals of drug prescriptions on the web site. Visitors are prompted to enter information relevant to the renewal. The web site in one embodiment maintains a database of visitors' medical and/or contact information and issues a membership ID or plan ID. The web site preferably maintains a database of information about doctors who are registered with the web site. Alternatively, visitors may enter their doctor's information each time. The visitor may then select a doctor from a list, or enter the doctor information, and use the site to request a prescription renewal from that doctor. The web site uses information entered by the visitor, or information previously provided by the visitor accessed from the web site's database, to format a fax or email to the doctor requesting a renewal of the visitor's prescription. The fax or email may contain the name, address, telephone number and prescription plan ID of the patient, the name, address, telephone number and DEA number of the doctor, the drug to be refilled, the quantity and dosage of the refill. The fax or email will contain the fax number and phone number or email address of the pharmacy (or Pharmaceutical Benefits Manager, “PBM”, for example Express Scripts.) Finally, the fax or email will contain a signature line or sufficient facility for electronic signature to be signed by the doctor. Upon completion of the request by the visitor, the system forwards the request directly to the doctor via fax or electronically. The doctor may then sign the request and fax or electronically transmit the request to a pharmacy or PBM. Preferably, the system sends the user information about his prescription and/or his illness and/or any new medication or treatment that may be available. In an alternate embodiment the web site may offer an opt-in buyer's club for obtaining discounts or information about prescriptions.

### BRIEF DESCRIPTION OF THE DRAWING

The foregoing and other features of the present invention will be more readily apparent from the following detailed description and drawing of an illustrative embodiment of the invention in which:

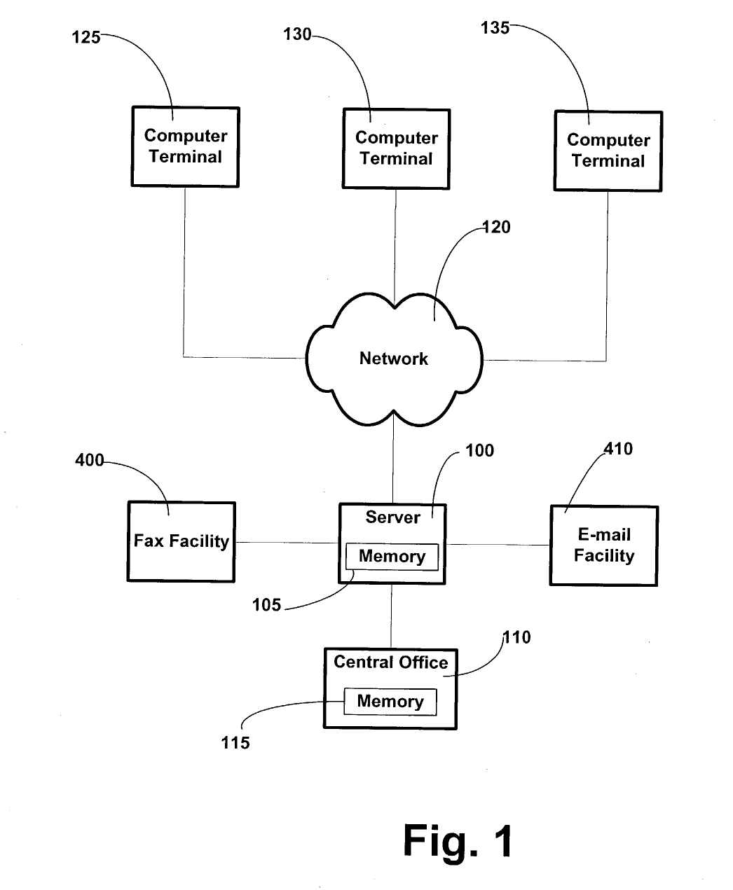

The only figure, FIG. 1, is an exemplary high level block diagram of a system for renewing prescriptions in accordance with the present invention.

### DETAILED DESCRIPTION OF THE PREFERRED EMBODIMENT

By way of example, the discussion of the system and method in accordance with the present invention is directed to renewal of prescriptions.

The Figure shows an exemplary embodiment of a high-level diagram of a system including a server 100 having a memory device 105. Server 100 has connected to it a central or main office 110 having a memory device 115. Server 100 is accessed by multiple computer terminals 125, 130, 135 connected via a network 120, such as the Internet. While the system and method in accordance with the present invention is described in the context of the Internet or world wide web, it can also be used in other network environments, such as a local area network (LAN), Intranet, wide area network (WAN), or various wireless technology platforms, where the system and software are accessible by both subscribers and end users alike from remote locations. Only three computer terminals are shown, however, any number of computers may be connected to network 120 through known communication interfaces, such as an external or built-in modem (not shown). Preferably, server 100 runs the necessary software to offer a “web site.” End users may access the web site from any computer terminal throughout the world having appropriate network Internet access and software, such as a web browser. The server 100 uses a secure server, such as Netscape™, using secure socket layer (SSL) protocols or alternative security means. Server 100 may be designed so that a user must employ a web browser that supports SSL. In a preferred embodiment, server 100 notifies the user if his web browser does not support SSL or if the particular version of the Internet access software installed by the end user falls below a minimum acceptable level of security functionality.

A doctor accesses the web site through the browser loaded on to his computer terminal 125, 130, 135 and a screen is generated asking whether the doctor wants to participate in the drug renewal program. In an exemplary embodiment, entry of this information may be part of a registration form for accessing the services of a particular web site. In one such embodiment, doctors may enter information such as their DEA number and their contact information. Server 100 receives the registration information of those doctors and stores the data in memory device 105. At least some, if not all, of the registration information provided by a doctor is forwarded by the server 100 to the central or main office server 110, which maintains a central database of information. It is contemplated that the doctor may be charged a fee for registering. Similarly, a pharmacy may register with the system and, preferably, be charged a fee.

The user accesses the web site through the browser loaded on his or her computer terminal 125, 130, 135 and a screen is generated, for example, asking the user for information relating to his or her contact information, medical history and his or her doctor. In an exemplary embodiment, entry of this information may be part of a registration form for accessing the services of a particular web site. In one such embodiment, the user may opt to become part of a buyer's club in order to obtain discounts on pharmaceuticals. One such web site that lends itself to register participants is a site that offers information relevant to a particular health condition and/or allows users to volunteer to be a participant in a clinical trial within a medical specialty, e.g., clinical trials in the prevention and/or treatment of HIV/AIDS. Server 100 receives the registration information of those users and stores the data in memory device 105. At least some, if not all, of the registration information provided by the user is forwarded by the server 100 to the central or main office server 110, for entry in the central database.

Personal medical information entered by the user is transmitted to the server 100. The web site in one alternative maintains a database of visitors' medical and/or contact information and issues a membership ID and/or prescription plan ID. The information is received by the server 100 and targeted additional information associated with the particular ailment, treatment or pharmaceutical good identified in the personal medical information is gathered or retrieved to be transmitted to the user. The additional information can be any data associated with the personal medical information such as newer drugs offered by different manufacturers including links to related web sites. Other information to be provided may include a published report on the efficacy of that drug, a new drug therapy that has greater efficacy, possible side effects of the particular drug or any other information that in some way is associated or relevant to the member's utilization information. By way of example, personal medical information may reveal that the user is currently purchasing a certain medication for the treatment of HIV/AIDS. Server 100 upon receiving the utilization data can access additional information such as new drug therapies and that information is transmitted to the user (e.g., via e-mail to his computer terminal) or accessible by the user when visiting the web site.

Immediately after registration or in a later session, the user accesses the web site through the browser loaded on his computer terminal 125, 130, 135 and a screen is generated asking whether the user wishes to renew a prescription. In an exemplary embodiment, the user will enter information such as the name and address of the patient, the name and address, telephone number, and DEA number of the doctor, the drug to be refilled, the quantity and dosage of the refill. In this embodiment, the user will enter the fax number and phone number or email address of the pharmacy (or PBM) or the user selects the pharmacy from a list that displays pharmacy contact and pricing information. In one embodiment, the web site will provide some or all of the aforementioned information by accessing data previously entered by the user, the doctor, or the pharmacy by extracting it from the database at the central or main office server 110. For example, the user may select a doctor or pharmacy from a list of doctors or pharmacies stored on the central or main office server 110. The list of doctors or pharmacies will provide contact information and pricing information whenever possible. Pharmacies will benefit from the direct marketing of their contact and pricing information to potential customers.

Once all the required information is entered or retrieved, the web site will format a request form to be sent to the doctor. In a preferred embodiment, this request will be a fax containing the name, address, telephone number, and prescription plan ID of the patient, the name and address and DEA number of the doctor, the drug to be refilled, the quantity and dosage of the refill. The fax or email will further contain the fax number and phone number or email address of the pharmacy or PBM. Finally, the fax or email will contain a signature line or sufficient facility for electronic signature to be signed by the doctor. A fax takes advantage of the fact that most doctors' offices have not fully integrated computers and email into their operations. The system and method of the invention may however take advantage of email or other suitable electronic means of transferring the request to the doctor.

The server 100 will forward the request form to fax facility 400 or email facility 410. Fax facility 400 or email facility 410 or other suitable electronic means of transfer will send the request directly to the doctor specified on the request.

Traditionally, prescriptions are renewed by telephone. This makes them lengthy and susceptible to transcription errors. The system and method in accordance with the present invention may be used to ensure that the doctor receives more complete and accurate information with which to renew the prescriptions. This invention and method also makes contact (e.g. telephone) and ID information available allowing the doctor and pharmacy to easily contact the patient, and allowing the pharmacy to easily contact the doctor, and allows doctors and pharmacies to have the patient ID handy for billing and recordkeeping. This invention will also save time by preprinting information that normally must be hand-written or typed by the doctor. This invention may result in cost savings to the patient because if the patient takes advantage of a buyer's club, that information can be added to the renewal request ensuring that the pharmacy or PBM provides the correct discount.

A fee is tabulated by server 100, for example, a percentage of the consumer's spending or a fixed transactional fee. In a preferred embodiment, the fee is accounted for by reducing the discount to the consumer by an appropriate amount. Alternatively, or in addition thereto, a fee for the services provided in operation of the web site may be realized by deriving revenue directly from the pharmaceutical manufacturer, the doctor or the pharmacy. It is desirable for drug companies to generate educational materials about the drugs manufactured by them, to be disseminated as part of the additional information sent from the server 100 to the consumer, because the web site can target consumers based on the particular drugs they use. Accordingly, revenue may be generated by assessing a fee to distribute this additional information to the consumer.

It is also within the intended scope of the present invention for the physician upon receipt of the renewal to submit the renewal electronically or by fax directly to the PBM or pharmacy. The user receives the prescribed drug without having to make a separate submission or go to the pharmacy. Additional information, triggered by the filling of the prescription, may automatically be sent to the consumer, e.g., electronically via e-mail. This information, for example, may include prescribing information (when and with what liquids the drug is to be taken, possible side effects or contraindications, etc.) that may be far more detailed than the pamphlet or insert that typically accompanies the prescribed drug.

Generally, a discount in the cost of the pharmaceutical goods can be obtained by participation in a buyer's club. A club with a larger membership and/or higher cost of the pharmaceutical goods being purchased, will receive a greater the discount in the cost. Renewal of prescriptions is obviously a service that would be used quite often by the members of a buyer's club. Accordingly, it is advantageous to combine the system and method in accordance with the present invention with existing services directed to a concentrated or specific population (e.g. associated with a specific medical condition) serviced at a single web site. One such population comprises visitors to an interactive question and answer web site directed to disseminating information related to a specific medical condition. Another web site may offer the option to join a buyers club. Another web site may offer information relating to doctors and pharmacies. Another web site may offer a means for volunteering to participate in clinical trials concerning a specific medical condition. As part of the navigation through the web site, the user may be given the opportunity to request renewal of prescriptions.

Thus, while there have been shown, described, and pointed out fundamental novel features of the invention as applied to a preferred embodiment thereof, it will be understood that various omissions, substitutions, and changes in the form and details of the devices illustrated, and in their operation, and the disclosed method may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

What is claimed:

1. A network-based system for renewing medical prescriptions, comprising:
a server connected to the network;
a database accessible to the server, the database containing identifying information for patients stored in association with information related to a prescription which has been written for a patient, the database also containing contact information for doctors;
a plurality of user computers connected to the network so as to permit access to the server, at least one user computer being operated by or for a patient; and
a communication facility controlled by the server to communicate with a doctor who wrote a prescription for a patient when the patient needs to renew the prescription.

2. The system of claim 1 wherein at lest one user computer is operated by or for a doctor.

3. The system of claim 1 wherein the communication facility provides communication by one of facsimile and electronic mail.

4. The system of claim 3, further comprising a responsive facility permitting prescription renewal by a doctor.

5. The system of claim 4 providing for one of signature and electronic identity verification of the doctor.

6. The system of claim 1, further comprising a responsive facility permitting prescription renewal by a doctor.

7. The system of claim 6 providing for one of signature and electronic identity verification of the doctor.

8. The system of claim 1 wherein the database contains information related to one of prescription insurance coverage of a patient and membership in a group medication purchasing facility offering discount prices to a participant.

9. The system of claim 1 wherein the database contains detailed medication information accessible through the network.

10. The system of claim 1, further comprising a notification facility notifying a patient of at least one of a prescription having been renewed by a doctor and filled.

11. The system of claim 4, further comprising a notification facility notifying a patient of at least one of a prescription having been renewed by a doctor and filled.

12. The system of claim 5, further comprising a notification facility notifying a patient of at least one of a prescription having been renewed by a doctor and filled.

13. The system of claim 6, further comprising a notification facility notifying a patient of at least one of a prescription having been renewed by a doctor and filled.

14. The system of claim 7, further comprising a notification facility notifying a patient of at least one of a prescription having been renewed by a doctor and filled.

15. A method for facilitating renewal of medical prescriptions, comprising:
maintaining accessible through a network a computerized database containing identifying information for a patient in association with information related to a prescription that has been written by a doctor for a patient, and contact information for the doctor; and
upon receiving a patient request through the network for renewal of a prescription, communicating the request to the doctor who wrote the prescription.

16. The method of claim 15 wherein the communication to the doctor is made by one of facsimile transmission and electronic mail.

17. The method of claim 15 wherein the communication to the doctor is made by through the network.

18. The method of claim 17, further comprising generating a prescription renewal by a doctor, making use of one of signature and electronic identity verification of the doctor.

19. The method of claim 16, further comprising generating a prescription renewal by a doctor, making use of one of signature and electronic identity verification of the doctor.

20. The method of claim 15, further comprising generating a prescription renewal by a doctor, making use of one of signature and electronic identity verification of the doctor.

21. The method of claim 15, further comprising maintaining in the database information about one of prescription insurance coverage of a patient and membership in a group medication purchasing facility offering discount prices to a participant.

22. The method of claim 15, further comprising maintaining a group medication purchasing organization and permitting patients to join the organization through the network.

23. The method of claim 15, further comprising maintaining in said database information about prescription medications.

24. The method of claim 15, further comprising notifying a patient when a prescription has been renewed by a doctor and refilled.

25. The method of claim 17, further comprising notifying a patient when a prescription has been refilled.

26. The method of claim 19, further comprising notifying a patient when a prescription has been renewed by a doctor and refilled.

27. The method of claim 18, further comprising notifying a patient when a prescription has been renewed by a doctor and refilled.

28. The method of claim 19, further comprising notifying a patient when a prescription has been renewed by a doctor and refilled.

29. The method of claim 20, further comprising notifying a patient when a prescription has been renewed by a doctor and refilled.

30. In an network-based system for renewing a patient's medical prescription, the prescription having been written by a doctor and to be filled by a pharmacy, the patient being a customer of a health maintenance organization, a method for improving service to the patient, comprising the steps of:
at least one of:
a) providing the patient with information about at least one of the medication prescribed for his medical condition, other medications for the same medical condition, and the medial condition;
b) providing the patient information about the doctor;
c) providing the patient information about the pharmacy;
d) providing the patient information about or membership in a buyers club offering reduced medication costs through a group comprised of patients; and
e) using information from the system, forming a group comprised of patients taking the same medication or having the same medical condition; and
charging a fee to at least one of the patient, the doctor, the pharmacy, the health maintenance organization, a manufacturer of the prescribed medication, a manufacturer of one of the other medications, the buyers club, and the group.
